(19) United States
(12) Patent Application Publication
(10) Pub. No.: US 2018/0009165 A1
(43) Pub. Date: Jan. 11, 2018

(54) THREE-DIMENSIONAL MANUFACTURING METHOD, AND APPARATUS FOR MANUFACTURING THREE-DIMENSIONAL MANUFACTURED OBJECT

(71) Applicant: CANON KABUSHIKI KAISHA, Tokyo (JP)

(72) Inventor: Teppei Agawa, Kawasaki-shi (JP)

(21) Appl. No.: 15/633,354

(22) Filed: Jun. 26, 2017

(30) Foreign Application Priority Data
Jul. 8, 2016 (JP) 2016-136418

(51) Int. Cl. B29C 64/153; B22F 3/105; B22F 3/24

(52) U.S. Cl. CPC B29C 64/153; B29C 64/268; B32B 2310/0825; B22F 2999/00; B33Y 50/02; B22F 2003/1056; B29C 64/273; B32B 2310/0843; B22F 2003/247

(57) ABSTRACT

A laser beam is irradiated onto material powder on a manufacturing table to solidify the material powder and form a solidified layer. The material powder is further deposited on the solidified layer and the laser beam is irradiated onto one part of the material powder to solidify the material powder. They are repeated to manufacture a manufactured object. An irradiation output value of the laser beam is determined based on measurement information regarding a deposition surface before depositing the material powder or regarding a surface state of the material powder after deposition that is acquired by a camera. Alternatively, the aforementioned irradiation output value is determined based on parity information regarding a number of solidified layers that were already solidified by irradiation of the energy beam, or determined in accordance with an irradiation output value used when solidifying a solidified layer solidified prior to deposition of the deposited material powder.

### BACKGROUND OF THE INVENTION

### Field of the Invention

The present invention relates to a three-dimensional manufacturing method in which an energy beam is irradiated onto one part of deposited material powder to solidify the material powder and form a solidified layer, and one part of material powder that is further deposited on the formed solidified layer is irradiated with an energy beam and solidified, and also relates to an apparatus for manufacturing a three-dimensional manufactured object.

### Description of the Related Art

A powder-layered manufacturing method is known as one method for manufacturing a three-dimensional manufactured object. In the powder-layered manufacturing method, a process in which a thin film of material powder is deposited and a laser is then irradiated onto a predetermined place on the thin film of material powder to cause fusion or cause sintering or baking of the material powder and thereby form a solidified layer is repeated to manufacture a manufactured object. In the powder-layered manufacturing method, the solidification state (fusion, sintering or baking, diffusion bonding state) of the powder changes according to the heat input amount to the material powder, and if an error occurs with respect to the powder amount of the thin film, there is a possibility that the characteristics of the manufactured object will change or the shape accuracy will decrease.

For example, with regard to the thickness of a material powder layer that is deposited, a phenomenon is known in which displacement of the manufacturing stage occurs due to the weight of the material powder, and as the manufacturing progresses, the amount of powder rises and the amount of displacement increases (Japanese Patent Application Laid-Open No. 2012-241261). In Japanese Patent Application Laid-Open No. 2012-241261, a problem that a difference arises between heat input amounts to the powder per unit volume due to the thicknesses of thin films not being constant throughout the manufacturing is recognized. According to the aforementioned Japanese Patent Application Laid-Open No. 2012-241261, to make the thickness of thin films that are deposited constant and suppress the influence of a difference that arises between heat input amounts to the powder per unit volume for respective layers, control is performed to deposit the powder so as to have a thickness that is calculated by assuming the amount by which the manufacturing stage will be displaced due to the weight of the powder.

A phenomenon is also known whereby a difference arises between heat input amounts to powder per unit volume as a result of warping of a manufacturing plate occurring due to thermal stress caused by the heat input of a laser and an error arising in the thickness of a powder spreading in accordance with the warpage amount (Japanese Patent Application Laid-Open No. 2013-163829). In Japanese Patent Application Laid-Open No. 2013-163829, a configuration is used in which a manufactured object that is taken as a base solidified layer is manufactured on a manufacturing plate, and the base solidified layer is manufactured until warping of the manufacturing plate and the base solidified layer no longer occurs. By this means, it is attempted to suppress the occurrence of errors in the thickness of the powder spreading that are attributable to the size of the warpage amount and thereby reduce the influence of errors that arise in heat input amounts to the powder per unit volume for each layer.

However, according to the conventional technology described in the aforementioned Japanese Patent Application Laid-Open No. 2012-241261 and Japanese Patent Application Laid-Open No. 2013-163829, although the thickness of material powder layers can be made constant, consideration is not given as to whether the material powder is spread out as expected with, for example, the intended uniformity, within the constant thickness of the thin film.

For example, to enhance the manufacturing accuracy it is conceivable to reduce the particle diameter of the material powder or the thickness of single layers of material powder. For example, it is conceivable to reduce the particle diameter of the material powder to 10 μm or less, or to reduce the thickness of single layers of material powder to 30 μm or less. However, in the case of a particle diameter of this kind or a layer thickness of such magnitude, a phenomenon sometimes arises such that powder does not spread as expected at an upper part of a place where the surface accuracy before depositing is high, and consequently the amount of powder decreases.

According to the findings of the inventors, the uniformity of deposited material powder is influenced by the substrate at the manufacturing area on which the material powder is deposited, that is, the surface state (surface accuracy, surface roughness and the like) of a deposition surface on which the material powder is newly deposited. The aforementioned deposition surface is, for example, the surface of a manufacturing plate (base plate) that constitutes the bottom of the manufacturing area on which material powder for a first layer is deposited, as well as the surface of a solidified layer (after solidification) of the previous layer.

Further, particularly in a case where the surface accuracy of such deposition surfaces is high (small amount of surface roughness), a phenomenon occurs such that the material powder does not spread neatly (for example, uniformly) when the next layer is deposited. Furthermore, conversely, there is a tendency for the surface accuracy of a solidified layer that is obtained by solidifying material powder that could not be deposited with uniformity in this way to be comparatively low (large amount of surface roughness), and a phenomenon whereby material powder is uniformly deposited on the solidified layer that has such low surface accuracy has been observed.

Thus, even if material powder layers can be deposited with a constant layer thickness each time, there is a possibility that the powder amount that is actually deposited will be reduced in a material powder layer in which the material powder could not be uniformly deposited. In this case, in the material powder layer in question, there is a possibility that the heat input amount to the powder per unit volume will be too large, and the characteristics of the manufactured object will change and the shape accuracy will decrease.

### SUMMARY OF THE INVENTION

An object according to the present invention is to suppress changes in the characteristics and a decrease in the shape accuracy of a manufactured object by appropriately controlling a heat input amount to material powder.

According to an aspect of the present invention, a method for manufacturing a three-dimensional manufactured object includes a process of irradiating an energy beam onto one part of material powder that is deposited in a manufacturing area to solidify the material powder and form a solidified layer, and further depositing material powder on the solidified layer that is formed and irradiating an energy beam onto one part of the material powder to solidify the material powder, further comprises: measuring a surface state of a deposition surface of a substrate before depositing the material powder, or a surface state of the material powder that is deposited in the manufacturing area, and controlling an irradiation output of the energy beam based on the measurement result.

According to a further aspect of the present invention, a method for manufacturing a three-dimensional manufactured object includes a process of irradiating an energy beam onto one part of material powder that is deposited in a manufacturing area to solidify the material powder and form a solidified layer, and further depositing material powder on the solidified layer that is formed and irradiating an energy beam onto one part of the material powder to solidify the material powder, further comprises: based on parity information regarding a number of solidified layers that are already solidified by irradiation of the energy beam, or using an irradiation output value of an energy beam used when solidifying a solidified layer that is solidified at a previous time before depositing the material powder, controlling an irradiation output of an energy beam for solidifying the material powder that is deposited in the manufacturing area.

By appropriately controlling a heat input amount to material powder, it is possible to enable the suppression of changes in the characteristics and a decrease in the shape accuracy of a manufactured object.

Further features of the present invention will become apparent from the following description of exemplary embodiments with reference to the attached drawings.

### BRIEF DESCRIPTION OF THE DRAWINGS

FIG. 1 is a schematic diagram illustrating a configuration example of a three-dimensional manufacturing apparatus capable of implementing the present invention.

FIGS. 2A, 2B, 2C and 2D are explanatory diagrams that sequentially illustrate the manner of performing a powder spreading process for a first layer in the apparatus illustrated in FIG. 1.

FIGS. 3A, 3B, 3C and 3D are explanatory diagrams that sequentially illustrate the manner of performing a powder spreading process for a second and subsequent layers in the apparatus illustrated in FIG. 1.

FIG. 4 is a block diagram illustrating a configuration example of a control system (control apparatus) of the apparatus illustrated in FIG. 1.

FIG. 5 is a flowchart illustrating the flow of three-dimensional manufacturing control procedures in the apparatus illustrated in FIG. 1.

FIG. 6 is a chart illustrating the relation between a deposition state of a material powder layer and a laser irradiation output in the apparatus illustrated in FIG. 1.

FIG. 7 is a chart illustrating an example of correlating various characteristic quantities that correspond to a surface state measured by a surface state measurement apparatus, and laser irradiation outputs in the apparatus illustrated in FIG. 1.

### DESCRIPTION OF THE EMBODIMENTS

Preferred embodiments of the present invention will now be described in detail in accordance with the accompanying drawings.

Hereinafter, a mode for implementing the present invention is described with reference to an embodiment illustrated in the accompanying diagrams. Note that the embodiment described hereunder is merely an exemplary embodiment and, for example, the detailed configuration can be appropriately changed by those skilled in the art within a range that does not depart from the gist of the present invention. Further, numeric values described in the present embodiment are for reference purposes, and do not limit the present invention.

### Embodiment 1

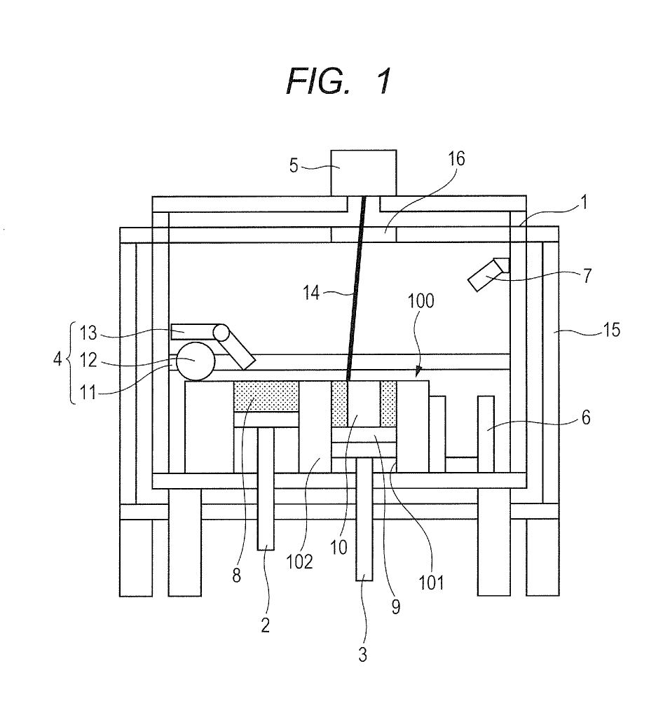

FIG. 1 illustrates an example of the configuration of a three-dimensional manufacturing apparatus that is capable of implementing the present invention. Hereunder, by means of the apparatus illustrated in FIG. 1, together with describing one embodiment of a manufacturing apparatus for manufacturing a three-dimensional manufactured object of the present invention, a method for manufacturing a three-dimensional manufactured object according to the present invention, and in particular a technique for controlling an irradiation output of an energy beam for solidifying material powder of each layer that is deposited is also described in detail.

The principal parts of the manufacturing apparatus shown in FIG. 1 are supported by a main frame 1. A supply stage 2, a manufacturing stage 3, a powder spreading unit 4, a manufacturing laser unit 5, a material powder recovery unit 6, and a camera 7 are installed on the main frame 1.

The supply stage 2 is arranged inside an opening portion (a cross-sectional shape of the opening is arbitrary) provided in a manufacturing table 102 so that the supply stage 2 can be driven to ascend and descend in the vertical direction by an unshown driving unit. Material powder 8 is loaded on an upper part of the supply stage 2. The supply stage 2 can push the material powder 8 by an amount that corresponds to a raised amount of the supply stage 2 upward to a position above the manufacturing table 102.

A manufacturing area 101 mainly includes an opening portion (a cross-sectional shape of the opening is arbitrary) that is provided in the manufacturing table 102, and a manufacturing stage 3 that is arranged so that the manufacturing stage 3 can be driven to ascend and descend in the vertical direction by an unshown driving unit that is provided therein.

A manufacturing plate 9 is installed on the manufacturing stage 3. A manufactured object 10 is manufactured one layer at a time on the manufacturing plate 9. For example, when manufacturing the first layer, through the manufacturing stage 3, the manufacturing plate 9 is controlled to a position at which the manufacturing plate 9 has been lowered from the upper face of the manufacturing table 102 by an amount that corresponds to the thickness of the intended material powder layer.

In the apparatus shown in FIG. 1, the powder spreading unit 4 is arranged as a material powder depositing apparatus. After the manufacturing plate 9 is lowered as described above, the powder spreading unit 4 is driven to deposit the material powder 8 on the manufacturing area 101.

The powder spreading unit 4, for example, includes a powder spreading unit movement shaft 11, a rotary roller 12 and a squeegee 13. The powder spreading unit movement shaft 11 is a drive mechanism for moving the rotary roller 12 and the squeegee 13 in the horizontal direction. The rotary roller 12 and the squeegee 13 can be moved, for example, to an arbitrary position on the upper part of the manufacturing area 101 at which the supply stage 2 and the manufacturing stage 3 are arranged, by the powder spreading unit movement shaft 11.

The squeegee 13 has a drive shaft 13b that is capable of controlling a swinging position of a tip portion 13a that is on the right side of the squeegee 13 in FIG. 1. The tip portion 13a of the squeegee 13 can be caused to swing downward as far as a position at which the tip portion 13a is lower than the undersurface of the rotary roller 12 by an unshown driving source, and furthermore, as necessary, can be caused to swing upward to above the undersurface of the rotary roller 12.

In the present embodiment, a laser beam 14 is used as an energy beam for solidifying a single material powder layer. In this case, the manufacturing laser unit 5 corresponds to an energy beam irradiation apparatus that irradiates an energy beam for solidifying the material powder layer. The manufacturing laser unit 5 that irradiates the laser beam 14 includes a scanning apparatus that includes a laser beam source, a collimator, a galvano scanner and the like, as well as an f-θ lens and the like. During manufacture of a single layer that forms a part of the manufactured object 10, a material powder layer that was deposited on the uppermost part of the manufacturing area 101 is scanned according to a scanning pattern that corresponds to the shape of the manufactured object 10 by the manufacturing laser unit 5. At this time, a specific site of the material powder layer that was subjected to radiation heating by the laser beam 14 is solidified in a shape that corresponds to the relevant cross-section of the manufactured object 10.

The camera 7, for example, includes a digital camera or the like. In the present embodiment, the camera 7 functions as a surface state measurement apparatus that includes all of the manufacturing area 101 in an image capturing region and measures a deposition surface on which material powder is to be deposited thereafter, or a surface state of material powder that was already deposited.

The camera 7 can photograph a deposition surface (substrate) before deposition of material powder, that is, the surface of the manufacturing plate 9 on which a first material powder layer is to be deposited that is disposed in the manufacturing area 101 or, at a stage at which manufacturing has progressed, can photograph the surface of an n^{th} solidified layer that was solidified at the uppermost part of the manufactured object 10. The camera 7 can also photograph the surface of material powder that was deposited, that is, the surface of a first material powder layer that was deposited on the surface of the manufacturing plate 9, or at a stage at which manufacturing has progressed, can photograph the surface of an n+1^{th} material powder layer (before solidifying) that was deposited on the upper part of the manufactured object 10.

In the present embodiment, utilizing an image photographed by the camera 7 of the above-described deposition surface (substrate) before deposition of material powder or the surface of material powder that was already deposited, the irradiation output of the laser beam 14 for solidifying material powder that is to be deposited thereafter or the material powder that was deposited is controlled.

In the manufacturing apparatus of the present embodiment, the manufacturing table 102, the powder spreading unit 4 and the camera 7 are arranged inside a manufacturing chamber 15 that is supported by a separate member from the main frame 1. On the other hand, the manufacturing laser unit 5 is disposed at an upper part on the outside of the manufacturing chamber 15. The laser beam 14 of the manufacturing laser unit 5 is irradiated through a laser transmitting window 16 that is disposed at the upper part of the manufacturing chamber 15. The laser transmitting window 16 is made from a light-transmitting material such as glass or resin, and as necessary is coated with an antireflection coating having optical properties that are determined according to a wavelength of the laser beam 14 and the like.

The manufacturing chamber 15 includes, for example, a vacuum chamber, and is configured to enable adjustment of the degree of vacuum inside the manufacturing chamber 15 or replacement of the atmosphere therein through an unshown pressure reducing path and gas supply path.

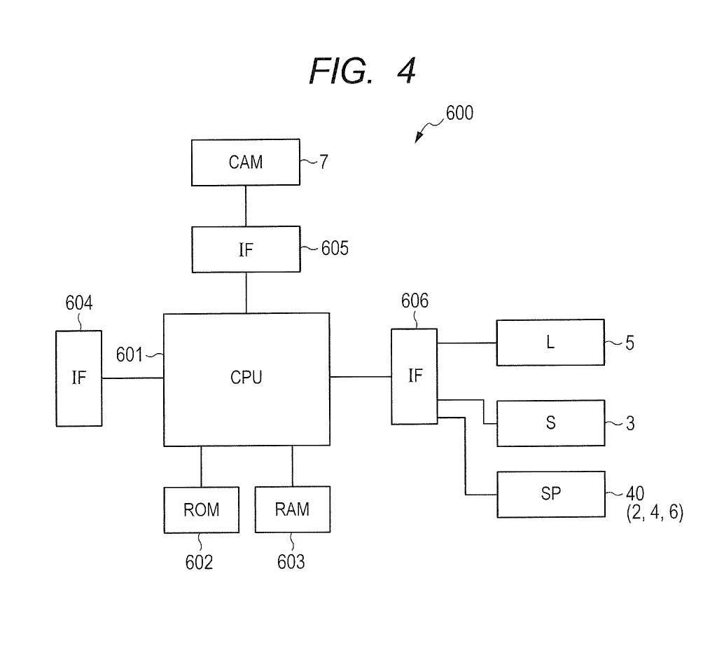

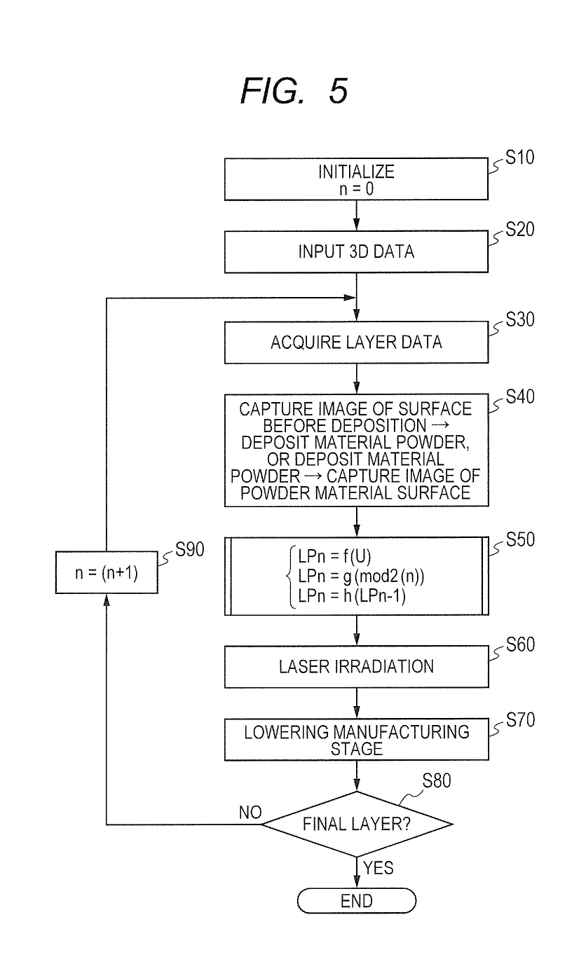

A configuration example of a control apparatus 600 (control system) that can be used for control of the manufacturing apparatus illustrated in FIG. 1 is shown in FIG. 4. The control system shown in FIG. 4 includes a CPU 601 that includes a general-purpose microprocessor and the like, a ROM 602, a RAM 603, and interfaces 604, 605 and 606 and the like. As necessary, in addition to the aforementioned components, a network interface or an external storage apparatus having, for example, a disk apparatus such as an SSD or a HDD may be arranged in the control apparatus 600.

The ROM 602 stores control programs and control data for causing the CPU 601 to execute, for example, basic control of the manufacturing apparatus in FIG. 1 and manufacturing control of the present embodiment. Note that, to enable updating of an access control program and control data stored in the ROM 602 later, a storage area for that purpose may be provided by a storage device such as an E(E)PROM. The RAM 603 includes a DRAM element and the like, and is used as a work area in which the CPU 601 executes various kinds of control and processing. A function relating to manufacturing control procedures that are described later is realized by the CPU 601 executing a control program (for example, FIG. 5) of the present embodiment. Note that, in a case where an external storage apparatus such as an SSD or a HDD is provided, the aforementioned control program or control data can be stored, for example, in a file format. The external storage apparatus such as an SSD or a HDD can also be utilized to provide a virtual storage area for supplementing the area of the main storage on the RAM 603.

Note that the external storage apparatus is not limited to an SSD or a HDD, and may include recording media such as various kinds of optical disks that are detachable, or a detachable SSD or HDD disk apparatus, or a detachable flash memory. Such various kinds of detachable computer-readable recording media, for example, can be used for installing and updating an access control program that forms one part of the present invention on the ROM 602 (E(E)PROM area). In this case, the various kinds of detachable computer-readable recording media store a control program that forms a part of the present invention, and the relevant recording medium itself also forms a part of the present invention.

The CPU 601 executes a manufacturing control program as well as a control program, firmware, an access control program and the like relating to manufacturing control that are stored on the ROM 602 (or in an unshown external storage apparatus). By this means, for example, each functional block (or control step) (of the control apparatus 600) that is illustrated in FIG. 4 is realized.

In FIG. 4, the interfaces 604, 605 and 606 are provided in the control apparatus 600. The interfaces 604, 605 and 606 can be constructed from a serial or parallel interface or from a network interface or the like according to various kinds of systems. Among these interfaces, for example, the interface 604 is used for receiving three-dimensional manufacturing data (the data format is optional such as 3D CAD or 3D CG data) from an external apparatus.

In a case where the camera 7 is provided in the manufacturing apparatus in FIG. 1, the CPU 601 uses the interface 605 for acquiring an image of the surface of, in particular, deposited material powder before solidification that was captured by the camera 7. Further, the interface 606 is used for control of constituent elements of the manufacturing apparatus (3D printer) by the CPU 601. In FIG. 4, the manufacturing stage 3, the manufacturing laser unit and a material powder supply/recovery system 40 are illustrated as constituent elements of the manufacturing apparatus (3D printer) that are connected to the interface 606. The material powder supply/recovery system 40 corresponds to, for example, the supply stage 2, the powder spreading unit 4 and the material powder recovery unit 6 and the like in FIG. 1.

Specifically, controlled elements that are controlled with the interface 606 include, for example, a rotary driving system for the powder spreading unit movement shaft 11 and the rotary roller 12 and the like, and an ascending/descending (and swinging) driving system for the supply stage 2, the manufacturing stage 3 and the squeegee and the like. Further, controlled elements that are controlled with the interface 606 also include a scanning driving system such as a galvano scanner of the manufacturing laser unit 5 and a driving power supply system that determines the irradiation output of the laser beam source.

In the present embodiment, the material of the material powder 8 may be an arbitrary metallic material or resin material or the like, and although not particularly limiting the present invention, in the present embodiment the material of the material powder 8 is fine particles of SUS 316 with a particle diameter of approximately 3 μm. Further, in the present embodiment, the material powder 8 that is deposited for one layer to form part of the manufactured object 10 in the manufacturing area 101 is, for example, powder that is deposited at a layer thickness of approximately 30 μm.

The manufacturing plate 9 corresponds to a foundation portion on which to manufacture the first layer of the manufactured object 10, and for example, material that is the same as (or has a similar composition to) the material of the material powder 8 is adopted as the material of the manufacturing plate 9. In order to uniformly deposit the material powder for the first layer of the manufactured object 10 and perform favorable manufacturing, surface properties that are too favorable (a high level of surface accuracy), such as in the case of a polished mirror surface, are not desirable as the properties of the (upper) surface of the manufacturing plate 9.

In the present embodiment, with respect to the above described conditions of the material (SUS 316) and particle diameter (3 μm) of the material powder 8 and the layer thickness (30 μm) when depositing, in order to favorably deposit the first layer, the surface accuracy, that is, the surface roughness, of the manufacturing plate 9 as the deposition surface for the first layer can be within the range described hereunder. According to the findings of the inventors, under the above described conditions, the surface roughness of the manufacturing plate 9 for favorably depositing, that is, with uniformity (“U” that is described later), the first layer of the material powder 8 is, for example, within a range of Ra=0.7 to 3.0 μm. Needless to say it is desirable to favorably deposit the first layer, and in this case, the manufacturing plate 9 is produced (or processed) so that the surface roughness of the upper face thereof is within this range (comparative coarseness). However, according to the laser irradiation output control of the present embodiment, even if the Ra value of the upper face of the manufacturing plate 9 is less than 0.7 and the surface accuracy is thus more favorable, since it is not impossible to solidify the first layer with favorable physical property values, such surface accuracy specifications for the manufacturing plate 9 may be adopted.

Note that, hereunder, a range of the surface roughness (for example, Ra=0.7 to 3.0 μm) of a deposition surface on which the material powder 8 can be deposited with uniformity (“U” that is described later) may be referred to using the characters “Raw”.

Conversely, in the case of surface properties in which the Ra value for the deposition surface is less than 0.7 (to 0) and the surface accuracy is high, as described above, the uniformity (“U” that is described later) of the deposition state of material powder that is deposited thereon decreases. With respect to a solidified layer of a first layer that is deposited and solidified on the manufacturing plate 9 having a surface roughness in the range described above (Raw: 0.7 to 3.0 μm), there is a high possibility that the Ra value of the surface of the solidified layer (deposition surface for the next layer) will have surface properties that have a high surface accuracy of less than 0.7 (to 0). Needless to say, when the material powder is solidified by laser irradiation, the uniformity (“U” that is described later) of the surface (deposition surface for the next layer) decreases and the surface roughness thereof enters the surface roughness range (Raw: 0.7 to 3.0 μm) for a deposition surface in which, conversely, the material powder can be favorably deposited.

As described above, in manufacturing control using the above described conditions for the material (SUS 316) and particle diameter (3 μm) of the material powder 8 and the layer thickness (30 μm) when depositing, conditions under which material powder is deposited with a high degree of uniformity (U) are obtained for every second layer. Consequently, because the surface accuracy increases too much when the layer in question is manufactured, when the next layer is deposited it is difficult to deposit the material powder with a high degree of uniformity (U), and therefore, when the relevant next layer solidifies, the surface accuracy decreases and a deposition surface (which, conversely, provides good conditions for depositing) is obtained. According to the findings of the inventors, in the case of the manufacturing conditions described above, high and low degrees of uniformity (U) of the deposition state of the material powder are alternately repeated for each of the layers. The manufacturing control of the present embodiment is based on this finding.

Next, an outline of the operations of the manufacturing apparatus in FIG. 1 is described. Here, a fundamental portion that is common with operations in a conventional 3D printer of this kind will be described. First, the material powder 8 is loaded onto the supply stage 2, and the manufacturing plate 9 is placed on the manufacturing stage 3.

Thereafter, adjustment of the degree of vacuum or adjustment of the atmosphere inside the manufacturing chamber 15 though the unshown pressure reducing path and gas supply path is performed as necessary. For example, the manufacturing chamber 15 is sealed and the inside is subjected to vacuum replacement. At this time, after vacuum replacement, inert gas replacement, for example, N2 replacement, H2 replacement or Ar replacement may be performed as necessary. Further, after replacing the vacuum and the relevant gas environment, in consideration of the possibility of an abrupt change in the properties of the material powder 8, the oxygen concentration can also be controlled so as to be less than a critical oxygen concentration. After replacement of the vacuum or the relevant gas environment, a layer of the material powder 8 for forming a first layer of the manufactured object 10 is deposited onto the upper part of the manufacturing plate 9 by the powder spreading unit 4. Note that the aforementioned adjustment of the degree of vacuum or adjustment of the atmosphere inside the manufacturing chamber 15 may be controlled, for example, by the control apparatus 600 (CPU 601) shown in FIG. 4, or may be controlled by another control system that is separately provided.

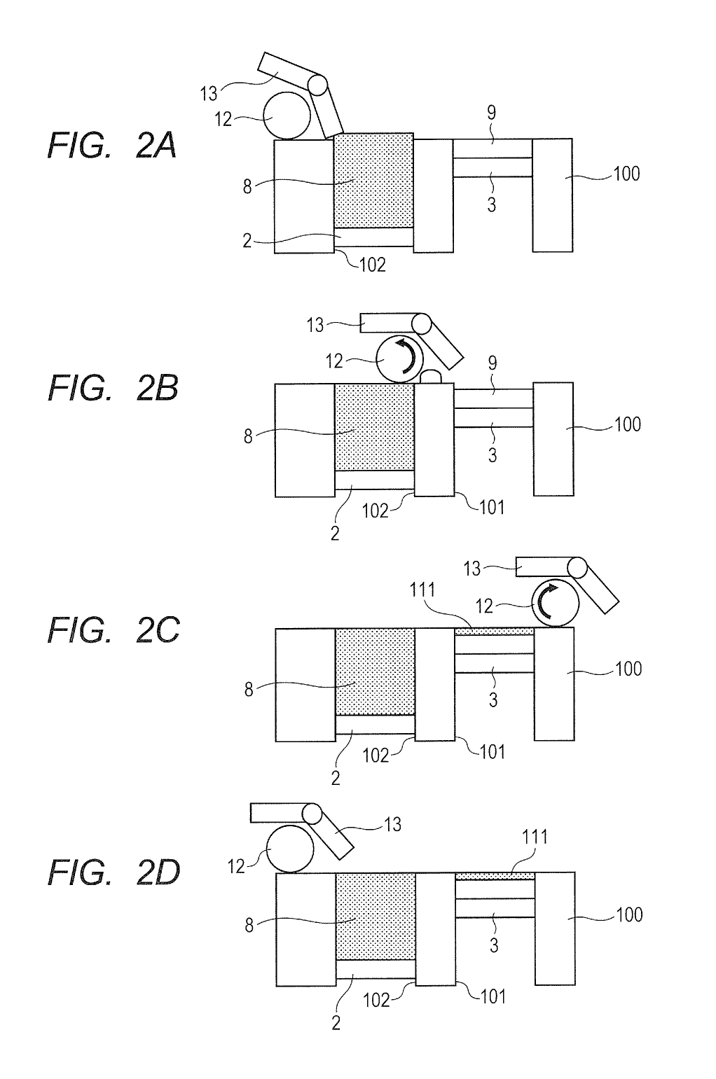

The process of depositing the first layer of the material powder 8 will now be described using FIGS. 2A to 2D. In the present embodiment, for example, it is assumed that fine particles of the material SUS 316 having a particle diameter of approximately 3 μm are used as the material powder 8.

FIG. 2A illustrates a state immediately before taking off a certain amount of material powder 8 from the supply stage 2. The CPU 601 of the control apparatus 600 controls an ascent/descent driving unit (unshown) of the supply stage 2 to raise the supply stage 2 by a certain amount. The amount (volume) of the material powder 8 that is deposited on the manufacturing plate 9 of the manufacturing area 101 is defined by the raised amount of the supply stage 2 and the area of the upper face of the supply stage 2.

In the present embodiment, the supply stage 2, for example, has a square shape in which each side is 140 mm. The material powder 8 of an amount for one layer is supplied by raising the supply stage 2 by, for example, 100 μm. After the supply stage 2 is raised, in a state in which the tip portion of the squeegee 13 has been lowered to below the lower end of the roller 12 through an unshown driving unit, the tip portion of the squeegee 13 is moved over the supply stage 2. By this means, a certain amount of the material powder 8 can be moved to the manufacturing stage 3 side by the squeegee 13.

In advance of the material powder 8 being moved to the manufacturing stage 3 side by the squeegee 13, the CPU 601 of the control apparatus 600 causes the manufacturing stage 3 to descend by a certain amount through an unshown ascent/descent driving unit to form a space in which to deposit the material powder 8. In the present embodiment, the manufacturing stage 3 and the manufacturing plate 9, for example, have square shapes in which one side is 140 mm, and at this stage the amount by which the manufacturing stage 3 descends is controlled to approximately 70 μm.

FIGS. 2A and 2B illustrate the manner in which the material powder 8 of only a certain amount is moved to the manufacturing stage 3 side from the supply stage 2. At this time, the CPU 601 of the control apparatus 600 causes the squeegee 13 and the rotary roller 12 of the powder spreading unit 4 to be moved synchronously by an unshown driving unit. On the outward journey of the powder spreading unit 4 that is illustrated in FIGS. 2A and 2B, the upper part of the manufacturing stage 3 is controlled to a state in which powder can be spread with the roller 12 by adopting a swing posture in which, in particular, the tip of the squeegee 13 is raised above the lower end of the rotary roller 12. Further, when moving the powder spreading unit 4 to the state illustrated in FIGS. 2A and 2B, while the rotary roller 12 is moving over the upper part of the manufacturing stage 3, for example, as indicated by an arrow in FIG. 2B, the lower end portion of the roller 12 rotationally drives so as to rotate in the same direction as the traveling direction. By this means, in the manufacturing area 101 (upper part of the stage 3), the material powder 8 is deposited while being smoothed out.

Note that, if the surface roughness of the manufacturing plate 9 is too coarse, the shape of the roughness will be transferred to the surface of the thin film, while if the surface roughness is too favorable, the material powder 8 will not be spread out neatly. With respect to the conditions of the present embodiment, it has been determined that powder spreading can be neatly performed if the surface roughness of the manufacturing plate 9 on which the material powder 8 is to be spread is within the range of Ra 0.7 to 3.0 μm. Note that the surface roughness of the manufacturing plate 9 may be changed in accordance with the kind of material powder 8 that is used and the thickness of a thin film to be manufactured.

FIG. 2C illustrates the state of the upper part of the manufacturing stage 3, that is, the upper part of the manufacturing plate 9, after the material powder 8 is spread. In this state, the material powder 8 is spread on the upper part of the manufacturing plate 9 to a thickness that corresponds to the amount by which the manufacturing stage 3 descended. In the present embodiment, a thin film having a thickness of 70 μm that is the amount by which the manufacturing stage 3 descended is spread on the upper part of the manufacturing plate 9. Next, a compression process for improving the density of the thin film of the material powder 8 is performed. First, the manufacturing stage 3 is raised by an amount that is less than the amount by which the manufacturing stage 3 descended at the time of spreading the material powder 8. In the present embodiment, the manufacturing stage 3 is raised by 40 μm.

The CPU 601 of the control apparatus 600 then causes the rotary roller 12 to move over the upper part of the manufacturing stage 3 from, for example, the opposite direction to the direction described above. During this movement of the rotary roller 12 over the upper part of the manufacturing stage 3, for example, the lower end portion of the rotary roller 12 is caused to rotate in the same direction as the traveling direction as indicated by an arrow in FIG. 2C to thereby compress the material powder 8.

FIG. 2D illustrates a state in which compressing of the material powder 8 at the upper part of the manufacturing stage 3 has ended, and the roller 12 has been returned to the initial position thereof. In this state, as a result of being compressed by an amount corresponding to the amount by which the manufacturing stage 3 ascended at the time of the compression process, the density of the material powder 8 that is spread on the upper part of the manufacturing plate 9 has improved from the state in which the powder of an amount corresponding to the amount by which the manufacturing stage 3 descended was spread on the upper part of the manufacturing plate 9.

In the present embodiment, the material powder layer that was spread to a thickness of 70 μm is compressed by 40 μm to form a material powder layer with a thickness of 30 μm. Physical properties of the manufactured object 10 (FIG. 1) to be manufactured can be adjusted as desired by performing this compression process to control the density of the thin film of the material powder 8. However, the above described compression process need not necessarily be performed, and in a case where the physical property values of the manufactured object 10 are such that it is not necessary to spread the material powder 8 at a high density, the compression process may be omitted by not performing the operation to raise the manufacturing stage 3 for the compression process. In that case, with respect to the control conditions of the present embodiment, the process of raising the manufacturing stage 3 by 40 μm at the time of the compression process is eliminated, and instead, a material powder layer of the same thickness can be deposited by changing the amount by which the manufacturing stage 3 descends before the powder spreading operation from 70 μm to 30 μm.

By performing the operations described above, a first layer of the material powder 8 can be deposited on the upper part of the manufacturing stage 3, that is, the upper part of the manufacturing plate 9.

A laser irradiation (solidification) process that is performed after a layer of the material powder 8 is deposited on the upper part of the manufacturing plate 9 illustrated in FIG. 1 will now be described. The CPU 601 of the control apparatus 600 causes the laser beam 14 to be irradiated by the manufacturing laser unit 5 onto a predetermined place on the material powder layer that was deposited as described above, to thereby cause fusion or cause sintering or baking of the material powder 8 to make the material powder 8 into a solidified layer and form the manufactured object 10. Needless to say, the irradiation range of the laser beam 14 with respect to the material powder layer is controlled to a range that is equivalent to a shape that corresponds to the relevant cross-section of the manufactured object 10 that is being manufactured.

The above-described powder spreading process and laser beam irradiation process are repeatedly executed to perform manufacturing until the manufactured object 10 becomes a predetermined shape. During the powder spreading process, the material powder 8 that cannot be loaded on the upper part of the manufacturing stage 3 is knocked down into the material powder recovery unit 6 and accumulated in the material powder recovery unit 6.

Upon the powder spreading process and the laser beam irradiation process being repeated until the final layer of the manufactured object 10 and the intended shape of the manufactured object 10 is arrived at, the manufacturing stage is raised and cleaning of the (unsolidified) material powder 8 that adheres to the periphery of the manufactured object 10 is performed. Because suction of the material powder 8 cannot be performed in a vacuum, in the case of a vacuum environment this cleaning process is executed after the vacuum environment is replaced with a gas environment in which the oxygen concentration is adjusted to be less than a critical oxygen concentration at which an abrupt change in the properties of the material powder 8 occurs. Although this cleaning process is generally performed manually by a worker, the cleaning process may also be performed by a robot apparatus or the like that is separately provided, and the form thereof does not particularly limit the present invention. After the cleaning process to clean the (unsolidified) material powder 8, the vacuum environment or the relevant gas environment inside the manufacturing chamber 15 is replaced with an atmospheric environment, and the manufactured object 10 is taken out. Thus, a three-dimensional manufactured object (manufactured object 10) can be manufactured.

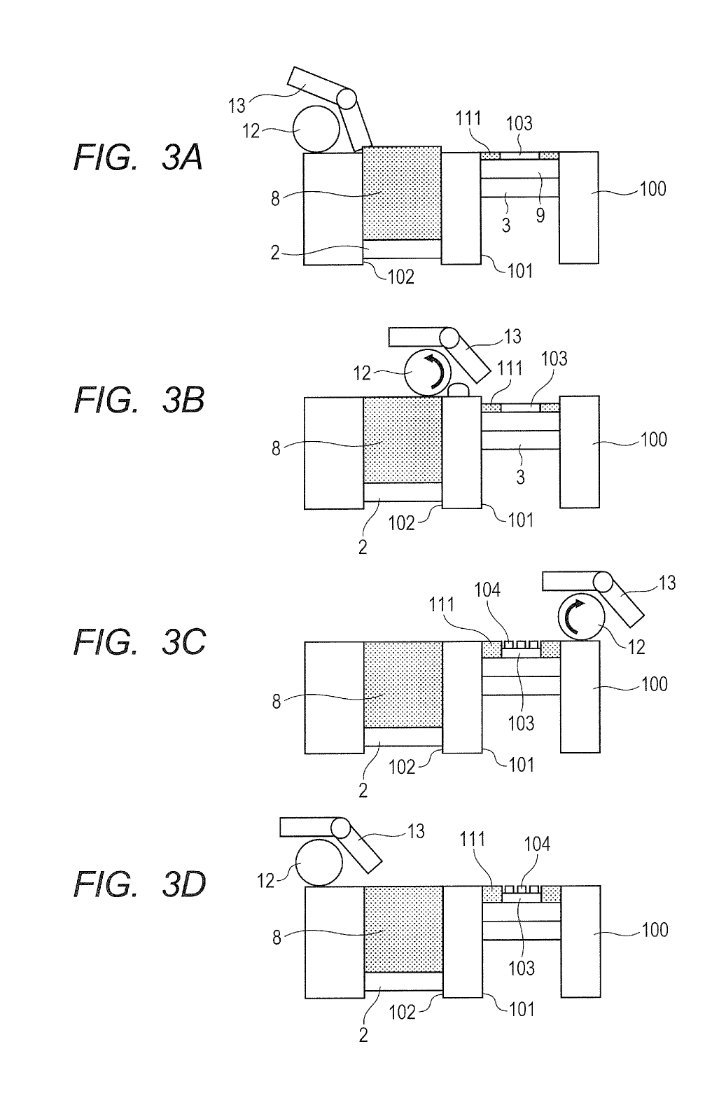

A phenomenon that is liable to arise during a powder spreading process for the second and subsequent layers in a case where, in particular, the particle diameter of the powder is made 10 μm or less and the thickness of the thin film for a single layer is made 30 μm or less to enhance the manufacturing accuracy will now be described in further detail using FIGS. 3A to 3D.

FIG. 3A illustrates a state immediately before taking off a certain amount of the material powder 8 from the supply stage 2 for a second layer. Similarly to the first layer, for the second layer also the CPU 601 of the control apparatus 600 raises the supply stage 2 by a certain amount to cause the material powder 8 to be supplied in an amount that corresponds to the raised amount and the receiving area of the supply stage 2. The CPU 601 of the control apparatus 600 then causes the tip portion of the squeegee 13 to move over the supply stage 2 in a state in which the tip portion of the squeegee 13 has been lowered to below the lower end of the roller 12. By means of this operation, only a certain amount of the material powder 8 is moved to the manufacturing stage 3 side by the squeegee 13. FIG. 3B illustrates the state after only the certain amount of the material powder 8 is moved to the manufacturing stage side from the supply stage 2 for the second layer. Similarly to the first layer, for the second layer also, the manufacturing stage 3 is lowered by a certain amount to form a space in which to spread the material powder 8. By raising the tip of the squeegee 13 to be above the lower end of the roller 12, a state is entered in which powder can be spread on the upper part of the manufacturing stage 3 with the roller 12.

The CPU 601 of the control apparatus 600 causes the roller 12 to move over the upper part of the manufacturing stage 3, and during this movement of the roller 12, as shown by an arrow in FIG. 3B, the lower end portion of the roller 12 is rotated so as to rotate in the same direction as the traveling direction and thereby deposit the material powder 8. In this case, although for the first layer the material powder 8 was deposited on the surface of the manufacturing plate 9 that is installed on the upper part of the manufacturing stage 3, for the second layer the material powder 8 is deposited on material powder 8 that was spread for the first layer and the surface of the manufactured object 10 that was manufactured by laser irradiation.

FIG. 3C illustrates a state after the material powder 8 is spread on the surface of the manufactured object 10 that was manufactured by laser irradiation and on the (unsolidified) material powder that was deposited as the first layer at the periphery of the manufactured object 10 on the upper part of the manufacturing stage 3.

Thus, there is no particular difficulty in spreading new material powder 8 on the upper part of the (unsolidified) material powder 8 that was deposited for the previous layer. However, because the surface roughness is too favorable on the upper part of the manufactured object 10 that was manufactured by the first layer, a phenomenon such that the material powder 8 is not neatly spread may occur.

After the material powder 8 is supplied onto the upper part of the manufacturing stage 3 as described above, for example, a compression process is performed that improves the density of the thin film of the material powder 8 in a similar manner to the first layer. First, the CPU 601 of the control apparatus 600 raises the manufacturing stage 3 by an amount that is less than the amount by which the manufacturing stage 3 descends when spreading the material powder 8. The CPU 601 of the control apparatus 600 then causes the roller 12 to move over the upper part of the manufacturing stage 3 from the opposite direction to the direction at the time of powder spreading. While the roller 12 is moving over the upper part of the manufacturing stage 3, the lower end portion of the roller 12 is rotated in the same direction as the traveling direction as indicated by an arrow in FIG. 3C to thereby compress the material powder 8.

FIG. 3D illustrates a state in which the roller 12 has finished compressing the material powder 8 at the upper part of the manufacturing stage 3, and has returned to the initial position thereof. Thus, as illustrated in FIG. 3D, a state in which the material powder 8 is not spread neatly (uniformly) on the upper part of the manufactured object 10 that was manufactured by the first layer may sometimes remain after ending the compression process.

Therefore, as a result, the amount of deposited material powder 8 is sometimes reduced on the upper part of the manufactured object 10 that was manufactured by the first layer. In this case, in the laser irradiation process, if the irradiation output (irradiation intensity) of the laser beam 14 that is the same as when manufacturing the first layer is used, a large amount of heat per unit volume will be applied to the material powder 8 of the second layer, and there is a possibility that the physical property values of the manufactured object 10 will change at this region.

In this case, if the material powder layer that is in a state in which the powder is not neatly (uniformly) deposited is subjected to radiation heating and solidified, manufacturing will be performed in which the roughness of the surface of the material powder layer is in a coarse state. Consequently, it will be possible to neatly spread the material powder 8 on the manufacturing face of the thin film in which the material powder 8 is not neatly spread. That is, a layer in which the material powder 8 is not neatly spread occurs for every second layer on the upper part of the manufactured object 10, and hence formation of a neatly spread layer and formation of a layer that is not neatly spread are alternately repeated.

That is, as described above, in a case where the material powder has particularly fine particles and the material powder layers that are deposited are thin, a material powder layer that is favorably (for example, having excellent uniformity) deposited will occur at alternate layers. For example, if the surface properties of the manufacturing plate 9 are suitable for depositing the material powder, the material powder layer that is the first layer can be favorably (uniformly) deposited, and the second layer will, conversely, be a material powder layer that lacks uniformity. Further, the third layer will once again be a material powder layer that is favorably (uniformly) deposited. Thereafter, a material powder layer that is favorably (uniformly) deposited will be formed for each odd-numbered layer and a material powder layer that lacks uniformity will be formed for each even-numbered layer in an alternating manner. Further, in a case where the surface properties of the upper face of the manufacturing plate 9 are not suitable for depositing material powder, such as when the upper face of the manufacturing plate 9 has undergone mirror-like finishing, the above described deposition characteristics (deposit result or surface state) of the material powder layers that are formed for the odd-numbered layers and even-numbered layers will be the opposite to the deposition characteristics described above.

Furthermore, it is not appropriate to adopt the same irradiation output (irradiation intensity) of the laser beam 14 for solidifying a material powder layer that was favorably (uniformly) deposited and a material powder layer whose deposition state is not favorable (uniform) and in which the total deposited amount is smaller. In this case, excessive radiation heating will be performed in the material powder layer that is not favorably (uniformly) deposited and in which the total deposited amount is smaller, and the physical property values of the manufactured object 10 will change at the position of the solidified layer that is formed.

Therefore, in the present embodiment the control apparatus 600 controls the manufacturing laser unit 5 so as to obtain irradiation outputs (irradiation intensities) that are suitable for the material powder layer that is favorably (uniformly) deposited and for the material powder layer whose deposition state is not favorable (uniform) and in which the total deposited amount is smaller, which alternately occur, respectively.

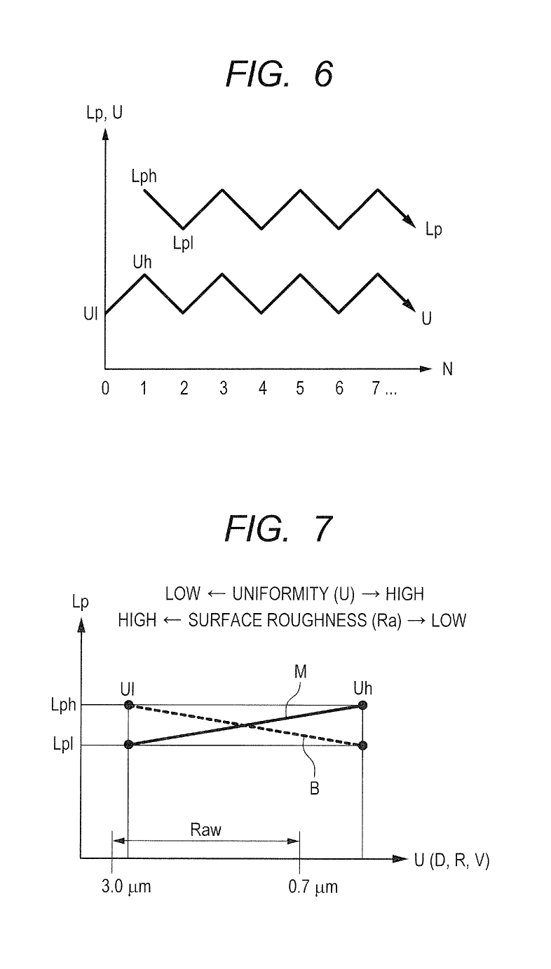

For example, FIG. 6 illustrates changes in the uniformity U (or a deposited powder amount) of each layer of material powder layers N that are deposited (solidified) in sequence from the lowest layer in a case where, in particular, the material powder has fine particles and the material powder layers that are deposited are thin. Further, in FIG. 6, reference character “Lp” denotes an irradiation output (irradiation intensity) of the laser beam 14 that is to be irradiated by the manufacturing laser unit 5 that is suited to the uniformity U (or powder amount) of each material powder layer n. In this case, an irradiation output value (large) that corresponds to a prescribed value is applied for solidification of material powder layers (N=1, 3, 5 . . . in FIG. 6) in which the uniformity U is favorable (a sufficient powder amount is deposited). On the other hand, an irradiation output value (small) that is decreased relative to the prescribed value is applied for solidification of material powder layers (N=2, 4, 6 . . . in FIG. 6) that are lacking in uniformity U (which have a smaller amount of deposited powder). By means of this control, the manufactured object 10 can be manufactured that has uniform physical property values over the entire manufactured object.

More specifically, in the present embodiment, the following manufacturing control is performed.

(1) The surface state of a deposition surface (surface of the manufacturing plate 9 or of the manufactured object 10 that has been solidified) on which to deposit the material powder is measured using a surface state measurement apparatus (for example, the camera 7). The irradiation output of an energy beam (laser beam) to be applied to solidify the material powder that is deposited on the relevant deposition surface is then controlled in accordance with the surface state that was measured.

(2) Alternatively, the surface state of material powder that has already been deposited is measured using a surface state measurement apparatus (for example, the camera 7). The irradiation output of an energy beam (laser beam) to be applied to solidify the material powder in question is then controlled in accordance with the surface state that was measured.

(3) This control utilizes the fact that the favorability (uniformity) of the deposits of material powder layers alternately changes. For example, the irradiation output of an energy beam (laser beam) that solidifies the material powder layers is controlled based on parity information with respect to the number of layers that have already been deposited or the number of solidified layers that have already been solidified by irradiating an energy beam. For example, if the number of solidified layers up to that time point is 0 (an even number), that is, when solidifying a material powder layer that is a first layer that was favorably deposited on the manufacturing plate 9, the prescribed irradiation output of the energy beam (laser beam) is used. On the other hand, in the case of a material powder layer which was deposited when the total number of solidified layers up to that time point was 1 (an uneven number), that is, was deposited on a first solidified layer that was solidified from a first material powder layer, and which was not deposited favorably (uniformly) and in which the total deposited amount is smaller, the irradiation output is set to a value that is reduced (small) relative to the prescribed value.

(4) Alternatively, to utilize the fact that the favorability (uniformity) of the deposits of material powder layers changes alternately, a prescribed irradiation output value (large) of the energy beam (laser beam) and an irradiation output value (small) that is reduced relative to the prescribed irradiation output value are prepared, and these irradiation output values are alternately applied. For example, when solidifying the respective material powder layers that were deposited, irradiation output values for the energy beam (laser beam) are applied in the order of the irradiation output value (large), the irradiation output value (small), the irradiation output value (large) . . . , respectively. In this case, for example, the irradiation output value (large or small) to be used during solidification of the relevant material powder layer can be selected according to the irradiation output value (small or large) that was used for solidification of the immediately preceding material powder layer. In this case, for example, as long as the irradiation output value (either one of “large” and “small”) to be used for solidification of the first material powder layer that is deposited on the manufacturing plate 9 is specified in advance, the respective irradiation output values (small or large) to be used to form the solidified layers for the second and subsequent layers can be appropriately selected thereafter.

Next, specific configuration examples according to the above described manufacturing controls (1) to (4) will be described in sequence.

The camera 7 that can capture an image of the upper part of the manufacturing stage 3 is arranged in the manufacturing apparatus (apparatus for manufacturing a three-dimensional manufactured object) illustrated in FIG. 1. The camera 7 can be used for the above described manufacturing control (1) or (2). The camera 7 can be used as a surface state measurement apparatus for measuring the deposition surface before depositing the material powder (surface of the manufacturing plate 9 or surface of the manufactured object 10 that was solidified), or the surface state of the material powder 8 that has been deposited.

For example, the CPU 601 of the control apparatus 600 can analyze an image photographed by the camera 7, and in a case where a deposition surface has been photographed, can determine whether or not the surface state of the deposition surface is a state such that material powder can be deposited with favorable uniformity (U) (a state in which the surface state of the deposition surface has comparatively low uniformity (U)). Further, in a case where the surface of the material powder 8 that has been deposited is photographed, the CPU 601 of the control apparatus 600 can determine whether or not the material powder 8 is deposited with favorable uniformity (U).

For example, before the powder spreading process (and compression process), the CPU 601 of the control apparatus 600 causes the camera 7 to capture an image of the deposition surface (surface of the manufacturing plate 9 or surface of the manufactured object 10 that has been solidified) on which the material powder is to be deposited. Further, after the powder spreading process (and compression process), the CPU 601 of the control apparatus 600 causes the camera 7 to capture an image of the material powder layer that has been deposited (and compressed).

Further, in a case where the deposition surface has been photographed, if the state is one in which the material powder can be deposited with favorable uniformity (U), the prescribed irradiation output value (large or prescribed value) is adopted as the irradiation output of the laser beam for solidifying a material powder layer to be deposited on the relevant deposition surface. Conversely, if the surface state of the deposition surface is a state with comparatively high uniformity (U), the deposition state of the material powder that is deposited thereon will be a state with comparatively low uniformity (U). In this case, an irradiation output value (small) that is reduced relative to the prescribed irradiation output value is adopted for solidification of the material powder deposited thereon.

On the other hand, in the case of photographing the surface of the material powder 8 that has been deposited, for a material powder layer with a favorable surface state, the prescribed irradiation output value (large or prescribed value) is adopted as the irradiation output of the laser beam for solidifying the relevant material powder layer. Conversely, with regard to a material powder layer whose surface state is not favorable, the irradiation output value (small) that is reduced relative to the prescribed irradiation output value is adopted.

By causing the CPU 601 of the control apparatus 600 to execute this kind of irradiation output control process, when the laser beam 14 is irradiated to cause fusion or cause sintering or baking of the material powder 8, a heat input amount that is applied to the material powder 8 can be controlled to a heat amount that is in accordance with the state of the powder that is spread. By this means, the manufactured object 10 having favorable quality can be manufactured in which the physical property values of the manufactured object 10 are as expected, in particular, in which the physical property values of the respective manufactured layers are uniform.

Note that the camera 7 as a surface state measurement apparatus may be replaced by a non-contact displacement gauge or shape measuring instrument, or by a measuring instrument such as a laser microscope or a white-light interferometer that can measure surface roughness. Further, the surface state measurement apparatus such as the camera 7 need not necessarily be fixedly arranged at a position (on the main frame 1) such as exemplified in FIG. 1. For example, a surface state measurement form may be adopted in which a surface state measurement apparatus that is configured to be movable by an unshown robot arm or a moving unit such as an XY stage performs measurement while scanning the upper part of the manufacturing stage 3. Alternatively, such a kind of moving unit that moves the surface state measurement apparatus may be configured utilizing a drive shaft that moves the powder spreading unit 4.

On the other hand, in the above described manufacturing control (3), the fact that the favorability (uniformity) with regard to deposition of material powder layers changes alternately is utilized. For example, the irradiation output of an energy beam (laser beam) that solidifies a material powder layer is controlled based on parity information regarding the number of material powder layers that were already deposited or the number of solidified layers that were already solidified by irradiation of an energy beam.

As described above, there is a possibility that the material powder 8 can be neatly (uniformly) deposited on the upper part of the manufacturing plate 9 that was processed to have a suitable surface roughness, and that the material powder 8 will not be neatly (uniformly) deposited on, for example, the next layer thereafter on the upper part of the manufactured object 10 or the like. That is, there is a tendency for a material powder layer that is neatly (uniformly) spread and a material powder layer that is not neatly (uniformly) spread to be repeated alternately. Therefore, for example, it is conceivable to utilize parity information regarding a number (n) of solidified layers that were already (deposited or) solidified by irradiation of an energy beam in the manufacturing control (3).

For example, the CPU 601 of the control apparatus 600 uses a counter or the like provided in the RAM 603 or a register to count the number of layers that are manufactured from the manufacturing plate 9, and can recognize that number. If the counter is, for example, a component that counts the number (n: an integer value) of solidified layers that were already solidified, the parity information of the numerical value of n can be utilized. Note that, the statement “number (n) of solidified layers that were already (deposited or) solidified by irradiation of an energy beam” that is used here corresponds to, in FIG. 6, a value obtained by subtracting 1 from the value of N.

For example, a calculation unit such as the CPU 601 can determine whether an integer (natural number) is an even number or an odd number by determining whether or not there is a remainder when the integer in question is divided by 2. This kind of determination function may be described, for example, by a notation such as mod2(n). For example, is a case where mod2(n)=0, n is an even number, and in a case where mod2(n)=1, n is an odd number.

In this case, if the surface state of the (upper face of) the manufacturing plate 9 is suitable for depositing material powder, immediately after material powder for a first layer is deposited, the number (n) of solidified layers that were already (deposited or) solidified is n=0, and the output of the aforementioned determination function is mod2(n)=0. Therefore, in consideration of the surface states of the material powder layers that alternately occur as described above, the prescribed irradiation output value (large) is adopted for the irradiation output of the laser beam used for solidification of the material powder layer having a favorable surface state for which the determination function is mod2(n)=0. Further, the irradiation output value (small) that is reduced relative to the prescribed output value is adopted for the material powder layer whose surface state is not favorable (deposition quantity is small) for which the determination function is mod2(n)=1.

Thus, the manufacturing control (3) utilizes the characteristic that surface states (or deposited powder amounts) of material powder layers that are favorable (uniform) or not favorable (not uniform) alternately occur. Further, the heat input amount (radiation heat amount) when irradiating the laser beam 14 to solidify the material powder 8 can be controlled to a heat amount that is adapted to the deposition state (or deposition quantity) of the material powder layer.

Accordingly, by means of the manufacturing control (3) also, a heat input amount that is applied to the material powder 8 can be controlled to a heat amount that is in accordance with the state of the spread powder. Therefore, according to the above described manufacturing control (3) also, the manufactured object 10 having favorable quality that has the physical property values expected of the manufactured object 10, in particular, has uniform physical property values for the respective manufactured layers, can be manufactured.

Note that it is possible to implement the above described manufacturing control (3) as long as at least the surface state of (the upper face of) the manufacturing plate 9 or the deposition state of a material powder layer that is deposited as a first layer directly on the manufacturing plate 9 can be identified. That is, for example, the irradiation output (“large” or “small”) of a laser beam to be used for solidification of the relevant material powder layer can be alternately selected by utilizing the parity (whether the value of mod2(n) is 1 or is 0) of the number (n) of (deposited layers or) solidified layers that were solidified up to the relevant time point. Therefore, the above described manufacturing control (3) can be easily and inexpensively implemented even in a manufacturing apparatus in which a unit such as the camera 7 is not arranged as a surface state measurement apparatus.

Further, the aforementioned manufacturing control (4) also utilizes the fact that the favorability (uniformity) with respect to depositing material powder layers alternately changes. In the manufacturing control (4), control is performed to alternately use the prescribed irradiation output value (large) and the irradiation output value (small) that is reduced relative thereto. For example, when deciding the irradiation output value for controlling the manufacturing laser unit 5, the CPU 601 of the control apparatus 600 can select the irradiation output value (“small” or “large”) to be used for the current material powder layer in accordance with the irradiation output value (“large” or “small”) that was used for solidification of the previous material powder layer.

The manufacturing control (4) is also control that applies, in an alternating manner, large and small irradiation output values for the laser beam 14 that is to be output from the manufacturing laser unit 5. Consequently, with respect to the manufacturing control (4) also, it is possible to implement the control as long as at least the surface state of (the upper face of) the manufacturing plate 9 or the deposition state of a material powder layer that is deposited as a first layer directly on the manufacturing plate 9 (or an irradiation output value to be applied for this layer) can be identified.

Furthermore, according to the above described manufacturing control (4) also, a heat input amount that is applied to the material powder 8 can be controlled to a heat amount that is in accordance with the state of the spread powder. Therefore, according to the above described manufacturing control (4) also, the manufactured object 10 having favorable quality that has the physical property values expected of the manufactured object 10, in particular, has uniform physical property values for the respective manufactured layers, can be manufactured.

FIG. 5 illustrates an example of control procedures for the overall process of manufacturing a three-dimensional manufactured object using the manufacturing apparatus illustrated in FIG. 1 that take into consideration the above described manufacturing controls (1) to (4) that are executed by the CPU 601 of the control apparatus 600. The control procedures illustrated in FIG. 5 correspond to a method for manufacturing a 3D manufactured object or to a control method for a manufacturing apparatus (FIG. 1) that manufactures a 3D manufactured object, and can be stored in advance as a control program of the CPU 601 on, for example, the ROM 602 (or an unshown external storage apparatus).

In step S10 in FIG. 5, the CPU 601 of the control apparatus 600 initializes to 0 the above described counter (n) that counts, for example, the number (n: an integer value) of (deposited or) solidified layers that were solidified up to the current time point. Note that, the counter (n) is not necessarily required in a case where a unit such as the camera 7 is not used as a surface state measurement apparatus, and in such a case this step S10 may be omitted.

Next, in step S20, three-dimensional model data (3D CAD, 3D CG data or the like) for a manufactured object that was prepared in advance is input to (received by) the CPU 601 through the interface 604 from an external apparatus.

Next, in step S30, the three-dimensional model data that was input is broken-down into laminate data having a horizontal cross section, and furthermore, layer data corresponding to respective layers, that is, data for the scanning trajectory for each manufactured layer is generated. Further, in step S30, as necessary, based on trajectory data for the relevant manufactured layer, the CPU 601 converts the data to drive data for a laser scanning system, for example, a galvano scanner. Note that, a scanning system of the manufacturing laser unit 5 is not limited to the aforementioned configuration. For example, the scanning system is not limited to a swinging scanning system such as a galvano scanner, and it is conceivable to use a rotational scanning system such as a polygon mirror as necessary. Further, although a laser beam (L) is assumed as the energy beam in the present embodiment, in the case of using another energy beam such as an electron beam for radiation heating of the material powder 8, the emission source thereof as well as the scanning system may be appropriately changed by a person skilled in the art.

Next, in step S40, the CPU 601 causes photographing by the camera 7 and depositing (and compressing) of the material powder layers as described in the aforementioned FIGS. 2A to 2D (or FIGS. 3A to 3D) and processing to be performed. In the case of the above described manufacturing control (1), the camera 7 is caused to capture an image of the deposition surface (surface of the manufacturing plate 9 or of the manufactured object 10 that has been solidified) before depositing the material powder. Further, in the case of the manufacturing control (2), the camera 7 is caused to photograph the surface of the material powder 8 that has been deposited on the aforementioned deposition surface.

The CPU 601 then acquires information relating to the surface state of the deposited material powder layer based on measurement information acquired from the camera 7 through the interface 605 (measurement information acquisition process). Note that this measurement information acquisition process that acquires measurement information from the camera 7 through the interface 605 may be included in step S50 that is described below.

In step S50, the CPU 601 uses any one of the methods described as the aforementioned manufacturing controls (1) to (4) to determine an irradiation output value LPn (“large” or “small”) to be provided to the manufacturing laser unit 5 for solidification of the deposited material powder layer (irradiation output control process).

In this case, pseudo-function expressions that correspond to the above described manufacturing controls (1) to (4) that determine the irradiation output value LPn (“large” or “small”) are described inside the frame in step S50 of FIG. 5. The initial expression LPn=f(U) corresponds to the above described manufacturing control (1) or (2), and corresponds to control for selecting the irradiation output value LPn (“large” or “small”) in accordance with a surface state, for example, the uniformity (U), of the measured surface that was acquired by the surface state measurement apparatus (the camera 7) (measurement information acquisition process).

Note that, an example of control for determining the irradiation output value LPn (“large” or “small”) in accordance with information relating to the surface state, for example, the uniformity (U), of a photographed surface that was acquired by the surface state measurement apparatus (the camera 7) in the present step S50 is described in more detail later in separate paragraphs.

Further, the second expression LPn=g(mod2(n)) corresponds to the above described manufacturing control (2), and for example, corresponds to control for selecting the irradiation output value LPn (“large” or “small”) based on parity information regarding the number (n: an integer value) of (deposited or) solidified layers that were solidified up to the current time point.

Furthermore, the third expression LPn=h(LPn−1) corresponds to the above described manufacturing control (4), and corresponds to control for selecting the irradiation output value LPn (“small” or “large”) to be used with respect to the current material powder layer in accordance with the irradiation output value (“large” or “small”) that was used for solidification of the previous material powder layer.

Next, in step S60, the CPU 601 drives the manufacturing laser unit 5 using the irradiation output value (“large” or “small”) that was determined by any one of the above described manufacturing controls (1) to (4) in step S50 (irradiation output control process). By this means, the relevant material powder layer is subjected to fusion or to sintering or baking and solidified. In step S70, the manufacturing stage 3 is lowered by only an amount required for depositing (and compressing) the next material powder layer.

In step S80, it is determined whether or not ((Y) or (N)) manufacturing up to the final layer of the manufactured object 10 has been completed. If it is determined here that manufacturing up to the final layer has not been completed, (as necessary) in step S90 the counter (n) is incremented by 1 and the operation returns to step S30 to repeat the above described processing.

For example, by means of the control procedures illustrated in FIG. 5, the manufacturing apparatus illustrated in FIG. 1 can be controlled to realize the method for manufacturing a 3D manufactured object of the present invention, or manufacturing control corresponding to a control method of a manufacturing apparatus that manufactures a 3D manufactured object can be realized. Further, according to the above described configuration, by the process for determining the irradiation output value (“large” or “small”) of the energy beam that corresponds to the above described manufacturing controls (1) to (4), the manufactured object 10 having favorable quality in which the physical property values of the manufactured object 10 are as expected, in particular, in which the physical property values of the respective manufactured layers are uniform can be manufactured.

<Irradiation output control in Manufacturing Control (1) and (2) (S50 in FIG. 5)>

FIG. 7 shows the relation of irradiation output values Lp (large: Lph, or small: Lpl) of the manufacturing laser unit 5 that should be selected with respect to information regarding the surface state, for example, the uniformity (U), of a photographed surface that was acquired by the surface state measurement apparatus (the camera 7).

In FIG. 7, the vertical axis is assigned to the irradiation output values Lp (large: Lph, or small: Lpl) of the manufacturing laser unit 5 that irradiates the energy beam onto the material powder, and the horizontal axis is assigned to information relating to the surface state of the photographed surface, for example, a scale of the uniformity (U) thereof. Further, for convenience, linear function-like straight lines (in reality, there is a possibility that the lines are higher-order curves) that are denoted by reference characters B and M, respectively, show the relation between the uniformity (U) of the surface state of a photographed surface acquired by the surface state measurement apparatus (the camera 7) and the irradiation output value Lp to be selected.

Here, in particular, the straight line B represents the relation between the uniformity (U) of the surface state of the deposition surface for material powder that was photographed and the irradiation output value Lp to be selected in the above described manufacturing control (1). Further, the straight line M illustrates the relation between the uniformity (U) of the surface state of the upper face of material powder that was photographed and the irradiation output value Lp to be selected in the above described manufacturing control (2).

Although in the description up to now the high-order concept “uniformity (U)” has been mentioned for use in relation to the surface state of the deposition surface for material powder or the upper face of material powder, in practice (for example, when implemented in a program), the “uniformity (U)” may be associated with the surface roughness (Ra value). For example, in FIG. 7, in the case of the deposition surface, the above described range Raw (3.0 μm to 0.7 μm) of the surface roughness (Ra value) in which material powder can be deposited with favorable “uniformity (U)” on the deposition surface is illustrated.

The straight line B in FIG. 7 represents the relation between a surface state and an irradiation output value to be adopted in the aforementioned manufacturing control (1). That is, as in the case represented by B in FIG. 7, when the uniformity (U) of the surface state of the deposition surface for material powder that was photographed is comparatively low, the CPU 601 uses the irradiation output value (large: Lph) for solidifying the material powder that is to be deposited thereafter. Such a case where the uniformity (U) of the surface state is comparatively low corresponds to the Raw range in which material powder can be deposited with favorable “uniformity (U)” on the deposition surface for the material powder. On the other hand, in a case where the surface roughness of the deposition surface for the material powder that was photographed exceeds the Raw range to the right side of FIG. 7 and the surface roughness is thus small and the surface accuracy is high, the CPU 601 adopts the irradiation output value (small: Lpl) for solidification of the material powder that is to be deposited.

On the other hand, the straight line M in FIG. 7 represents the relation between a surface state and an irradiation output value to be adopted in the aforementioned manufacturing control (2). That is, if the surface roughness of the upper face of material powder that was photographed is within the above described Raw range, it indicates that the uniformity (U) of the surface state of the deposited material powder is comparatively low, as in the case of the straight line B in FIG. 7. In this case, it can be determined that the material powder that is deposited includes a region in which the material powder is comparatively sparse, and as a result the deposition quantity of material powder that is deposited is small. Consequently, there is a possibility that if the irradiation output value (large: Lph) is used, the radiation heat amount will be excessive and will generate an undesirable change in the physical properties. Therefore, if the surface roughness of the upper face of material powder that was photographed is within the above described Raw range, the CPU 601 adopts the irradiation output value (small: Lpl) for solidification of the material powder that was photographed. On the other hand, in a case where the surface roughness of the upper face of the material powder that was photographed exceeds the Raw range to the right side of FIG. 7 and the surface roughness is thus small and the surface accuracy is higher, the uniformity (U) of the surface state of the deposited material powder is high and the deposition state is favorable. In this case, since the deposition quantity of the material powder that is deposited is sufficient as expected, the CPU 601 uses the irradiation output value (large: Lph) for solidification of the material powder that is deposited.

Thus, the magnitude relations between the irradiation output value and physical property quantities, for example, surface roughness, relating to the uniformity (U) of the surface state of a measured surface that was photographed are opposite between the manufacturing controls (1) and (2). However, the purpose of these controls is the same, and large (Lph) is adopted as the irradiation output value for solidification of a material powder layer that will be deposited (was deposited) uniformly with a sufficient deposition quantity, while conversely small (Lpl) is adopted as the irradiation output value for solidification of a material powder layer that lacks uniformity and for which the deposition quantity is not sufficient. Note that, in the manufacturing controls (1) and (2) also, as a result, a parity (alternating) property acts such that, when depositing the next layer after a material powder (solidified) layer that was deposited and solidified with favorable uniformity (U), the deposition characteristics (degree of uniformity and deposition quantity) decrease due to the height of the surface accuracy. Consequently, as the actual control results, the control results with respect to the irradiation output value of the energy beam are executed in an alternating layer pattern that is substantially the same as in the case of the manufacturing controls (3) and (4).

Note that if using an apparatus such as a white-light interferometer or a laser microscope as the surface state measurement apparatus instead of the camera 7, since these apparatuses are capable of outputting a value of the surface roughness, control can be performed that utilizes the correlation between the surface roughness and the irradiation output value that is indicated above.

On the other hand, when using the camera 7 (such as a common digital camera) as the surface state measurement apparatus, there is a possibility that another measurement amount can be utilized as a physical property quantity relating to the uniformity (U) of the surface state of a measured surface that was photographed. For example, reference characters “D” and “F” that are described in parentheses with respect to U on the horizontal axis in FIG. 7 represent values for “density” (of distribution information) (D) and “spatial frequency” (F) of a photographed image. Needless to say, these values may be thought of as a scale of the uniformity (U) of the surface state that corresponds to the granularity or the surface accuracy or surface roughness or the like of the measured surface.

Accordingly, from an image photographed by the camera 7, the CPU 601 acquires values for the “density (density average value or density distribution)” (D) and the “spatial frequency” (F) of the image. Further, a data table in which values for “density (density average value or density distribution)” (D) and “spatial frequency” (F) are correlated with irradiation output values with waveforms such as represented by B and M in FIG. 7 is prepared in advance, and an irradiation output value can be determined by referring to the data table. Such a data table can be created based on measurement results obtained by experimentation in advance. This is, with respect to program implementation, manufacturing control may be performed that determines an irradiation output value directly based on values for “density (density average value or density distribution)” (D) and “spatial frequency” (F) of an image acquired from images photographed by the camera 7. In this case, using the camera 7 (such as a common digital camera) that does not have a particular function that outputs the surface roughness or the like, the irradiation output value Lp of the manufacturing laser unit 5 can be determined simply and inexpensively and by high-speed processing.

Note that, the CPU 601 may calculate characteristic amounts such as the surface roughness (R in FIG. 7) or the amount of material powder that is deposited (per unit area) (V in FIG. 7) based on values of photographed information obtained by the camera 7, for example, values for “density (density average value or density distribution)” (D) and “spatial frequency” (F). Further, the CPU 601 may determine the irradiation output value Lp of the manufacturing laser unit 5 by using the surface roughness (R in FIG. 7) or the amount of material powder that is deposited (per unit area) (V in FIG. 7) that was calculated based on image analysis as a scale of the uniformity (U) of the surface state. In this case also, the irradiation output value can be determined by a table calculation method that utilizes a data table that is similar to the data table described above. Note that, depending on the specifications of the camera 7 that is employed or the specifications of an image processing library that the CPU 601 utilizes, information regarding “luminance (luminance average value or luminance distribution)” may be utilized in place of the above described “density (density average value or density distribution)” (D).

If the relation between irradiation output values and the uniformity (U) of a surface state that has continuity as illustrated in FIG. 7 is prepared in advance as a data table, the CPU 601 can select an irradiation output value for an irradiation region of the energy beam that corresponds to a specific site in a photographed image obtained by the camera 7. In this case, conversion data such as a homogeneous transformation matrix obtained by associating a coordinate system for scanning the laser beam 14 of the manufacturing laser unit 5 and a coordinate system in the photographing frame of the camera 7 is prepared in advance in the CPU 601. Further, in accordance with the uniformity (U) (or the aforementioned density, luminance, spatial frequency or the like) at the specific site in the photographing frame of the camera 7, the CPU 601 selects an irradiation output value for irradiation at a spot in the scanning coordinate system of the laser beam 14 that corresponds to the specific site. By performing this kind of control, for each specific site in a single material powder layer, an appropriate irradiation output value can be selected in accordance with the uniformity (U) (or the aforementioned density, luminance, spatial frequency or the like). Note that, in this case, evaluation of the uniformity (U) (or the aforementioned density, luminance, spatial frequency or the like) at specific sites in the photographing frame of the camera 7 may be executed only for sites that are to be scanned by the laser beam 14 in accordance with the layer data (S30 in FIG. 5). There is thus a possibility that the computation load of the CPU 601 can be reduced.

Among the above described configurations, according to the configuration that uses a surface state measurement apparatus to acquire measurement information regarding the surface state of a deposition surface before depositing material powder, an irradiation output value of an energy beam to be irradiated onto the material powder in question can be determined that is adapted to the deposition state of the material powder that will be deposited on the deposition surface. Further, according to the configuration that acquires measurement information of the surface state of deposited material powder by means of the surface state measurement apparatus, the deposition state of the material powder can be identified in accordance with the acquired surface state. The irradiation output value of an energy beam for solidifying the material powder in question that is adapted to the deposition state of the material powder can then be determined.

Furthermore, the configuration that utilizes parity information regarding the number of solidified layers that were already solidified by irradiation of an energy beam is a configuration that utilizes a characteristic that a material powder layer having a favorable (uniform) deposition state and a material powder layer having a deposition state that is not favorable (not uniform) alternately occur. In this case, an irradiation output value of an energy beam for solidifying material powder that is adapted to the deposition state of the material powder in question can be determined by utilizing parity information regarding the number of solidified layers that were already solidified by irradiation of an energy beam. For example, taking the surface state of the manufacturing plate that is disposed at the bottom of the manufacturing area as the base point for control, the irradiation output value of an energy beam for solidifying material powder that is adapted to the deposition state of the material powder in question can be determined utilizing the aforementioned parity information.

Further, the configuration that uses an irradiation output value of an energy beam used when solidifying a solidified layer that was solidified the previous time before deposition of the material powder in question utilizes the characteristic that a material powder layer having a favorable (uniform) deposition state and a material powder layer having a deposition state that is not favorable (not uniform) alternately occur. For example, taking the surface state of the manufacturing plate that is disposed at the bottom of the manufacturing area as the base point for control, an irradiation output value of an energy beam for solidifying the material powder in question is determined using the irradiation output value that was used when solidifying a solidified layer that was solidified the previous time before deposition of the relevant material powder. By this means, an irradiation output value of an energy beam for solidifying the relevant material powder that is adapted to the deposition state of the material powder can be determined.

By determining an irradiation output value of an energy beam for solidifying deposited material powder by means of any one of the manufacturing controls described above, a heat input amount when solidifying the material powder in question can be controlled to a radiation heat amount that is adapted to the deposition state of the material powder. By this means, a manufactured object having favorable quality can be manufactured for which changes in the characteristics and a decrease in the shape accuracy of the manufactured object are suppressed, and which has physical property values expected of the manufactured object, and in particular has uniform physical property values for each manufactured layer.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-136418, filed Jul. 8, 2016, which is hereby incorporated by reference herein in its entirety.

What is claimed is:

1. A method for manufacturing a three-dimensional manufactured object that includes a process of irradiating an energy beam onto one part of material powder that is deposited in a manufacturing area to solidify the material powder and form a solidified layer, and further depositing material powder on the solidified layer that is formed and irradiating an energy beam onto one part of the material powder to solidify the material powder, further comprising:
measuring a surface state of a deposition surface of a substrate before depositing the material powder, or a surface state of the material powder that is deposited in the manufacturing area, and
controlling an irradiation output of the energy beam based on the measurement result.

2. The method for manufacturing a three-dimensional manufactured object according to claim 1, wherein a result of measurement of a surface state of the material powder that is deposited in the manufacturing area is a surface state at a specific site of the material powder that is deposited in the manufacturing area, and an irradiation output of the energy beam that is irradiated for solidifying the specific site is determined in accordance with the result of measurement of the surface state at the specific site.

3. The method for manufacturing a three-dimensional manufactured object according to claim 1, wherein the surface state measurement result is information regarding surface roughness.

4. The method for manufacturing a three-dimensional manufactured object according to claim 1, wherein an image capturing apparatus that captures an image of an image capturing region including the manufacturing area is used for measurement of the surface state.

5. The method for manufacturing a three-dimensional manufactured object according to claim 4, wherein information regarding surface roughness is acquired as a result of measurement of the surface state based on an image captured by the image capturing apparatus.

6. The method for manufacturing a three-dimensional manufactured object according to claim 4, wherein an irradiation output of the energy beam is determined based on an average value or distribution information of a density or a luminance of an image that is captured by the image capturing apparatus.

7. The method for manufacturing a three-dimensional manufactured object according to claim 4, wherein an irradiation output of the energy beam is determined based on a spatial frequency of an image that is captured by the image capturing apparatus.

8. The method for manufacturing a three-dimensional manufactured object according to claim 4, further comprising: analyzing an image that is captured by the image capturing apparatus to acquire a deposition quantity of the material powder that is deposited in the manufacturing area, and determining an irradiation output of the energy beam to be irradiated onto the material powder based on the deposition quantity that is acquired.

9. A method for manufacturing a three-dimensional manufactured object that includes a process of irradiating an energy beam onto one part of material powder that is deposited in a manufacturing area to solidify the material powder and form a solidified layer, and further depositing material powder on the solidified layer that is formed and irradiating an energy beam onto one part of the material powder to solidify the material powder, further comprising:
based on parity information regarding a number of solidified layers that are already solidified by irradiation of the energy beam, or
using an irradiation output value of an energy beam used when solidifying a solidified layer that is solidified at a previous time before depositing the material powder,
controlling an irradiation output of an energy beam for solidifying the material powder that is deposited in the manufacturing area.

10. The method for manufacturing a three-dimensional manufactured object according to claim 1, wherein the energy beam is a laser beam.

11. The method for manufacturing a three-dimensional manufactured object according to claim 9, wherein the energy beam is a laser beam.

12. A non-transitory computer-readable recording medium storing a control program for operating a computer to execute each of the measuring and the controlling in the method for manufacturing the three-dimensional manufactured object according to claim 1.

13. A non-transitory computer-readable recording medium storing a control program for operating a computer to execute each of the measuring and the controlling in the method for manufacturing the three-dimensional manufactured object according to claim 9.

14. A three-Dimensional manufacturing apparatus executing a method for manufacturing a three-dimensional manufactured object, the apparatus comprising: an energy beam irradiating unit irradiating an energy beam; a material powder depositing unit configured to deposit material powder in a manufacturing area; a surface state measuring unit; and a control unit, wherein, based on measurement information regarding a surface state acquired from the surface state measuring unit, the control unit controls an irradiation output of the energy beam from the energy beam irradiating unit onto the material powder deposited by the material powder depositing unit.
